(19) United States
(12) Patent Application Publication
(10) Pub. No.: US 2008/0133742 A1
(43) Pub. Date: Jun. 5, 2008

(54) Presence model for presence service and method of providing presence information

(75) Inventors: Alain Southiere, Montreal (CA); Andy Pearson, Liverpool (GB); Gwenael Le Bodic, Montreal (CA); Haraldur Thorkelsson, Montreal (CA); Jean Regnier, Laval (CA); Manuel Laflamme, Brossard (CA)

Correspondence Address: COATS & BENNETT/OZ, 1400 CRESCENT GREEN, SUITE 300, CARY, NC, 27518, US

(73) Assignee: OZ Communications Inc., Montreal (CA)

(21) Appl. No.: 11/945,294

(22) Filed: Nov. 27, 2007

Related U.S. Application Data
(60) Provisional application No. 60/867,862, filed on Nov. 30, 2006.

(51) Int. Cl. G06F 15/173

(52) U.S. Cl. 709/224

(57) ABSTRACT

A presence server comprises a state machine to maintain current machine states for a plurality of users, and a mapper to map the current machine state for each user to a corresponding presence status.

### RELATED APPLICATION

This application claims the benefit of U.S. Provisional Patent Application 60/867,862, filed Nov. 30, 2006, which is incorporated herein by reference.

### BACKGROUND

The present invention relates generally to presence services for mobile devices and, more particularly, to a presence model for instant messaging between mobile users, or between mobile and fixed users.

Cellular networks were originally developed to provide primarily voice services over circuit-switched networks. Although circuit-switched networks are still in widespread use, the current trend is toward packet-switched networks that provide high speed packet data services in addition to voice services. The high-speed packet data services currently offered enable mobile users to surf the web, read e-mail, download video and audio files, and do other things that Internet users can do on fixed networks.

Consumer demand for mobile data services is growing rapidly. One of the services in greatest demand by mobile users is instant messaging (IM). Desktop IM over fixed network has gained widespread acceptance. Currently, there are more than 100 million registered users of instant messaging services and more than 50 million regular users. Based on the success and adoption rate of desktop instant messaging, wireless service providers are hoping to capitalize on the demand for IM services by extending the same services to mobile users.

Most of the presence models for IM evolved in the context of fixed networks and have been adapted to the usage patterns of PC users. One problem in extending IM services to mobile users is that existing presence models do not fit the usage patterns of mobile users. For instance, the status “away” is generally taken to mean that the user is away from the computer and consequently unavailable to engage in instant messaging conversations. In the mobile environment, the status “away” may not be very relevant since mobile users typically carry their devices with them. Similarly, the “on line” and “off line” statuses, which indicate the connection state of the user, may not accurately reflect the connection state of a mobile user due to the integration of instant messaging and presence services with other applications (e.g., presence enhanced phone book, threaded conversations in the message inbox, etc.). With this integration, the connection state of the user becomes more complex. The user is not always required to log in or log out of the instant messaging application. Instead, the mobile device may transparently log in during power up and log out during power down without any user intervention. Thus, the instant messaging and presence application may run in the background even when the mobile user is not actively engaged in instant messaging conversations. Thus, the “on line” and “off line” statuses may not accurately reflect the status of a mobile user.

Because the usage patterns of mobile and PC users are different, new presence models are needed for mobile users to more accurately reflect the status of mobile users.

### SUMMARY

The present invention provides a method and apparatus for maintaining presence information. In one exemplary embodiment, a presence server comprising a finite state machine and a mapper is provided. The finite state machine maintains current machine states for a plurality of users and outputs state updates indicative of the current machine states of said users responsive to state transitions. The mapper receives state updates from the state machine and maps said current machine states of said users to corresponding presence statuses. In a preferred embodiment, the machine state for each user is maintained by a separate dedicated instance of the finite state machine.

In one exemplary embodiment, the current states of the state machine include the “Available” state, the “Inactive” state, and the “Unavailable” state. The state machine is configured to enter the “Available” state when the corresponding user logs into the presence server. The state machine transitions from the “Available” state to the “Inactive” state when the user is inactive for a first predetermined period of time, and transitions from the “Inactive” state to the “Unavailable” state when the user is inactive for a second predetermined period of time. The state machine may further include an “Active” state. The state machine may be configured to enter the “Active” state when the corresponding user logs into the presence server in response to an invitation from another user. The state machine may also be configured to transition from the “Inactive” state or the “Available” state to the “Active” state responsive to the detection of user instant messaging activity, and to transition from the “Active” state to the “Available” state when the user is inactive for a third predetermined period of time.

In one embodiment, the state machine further generates message delivery rules responsive to state transitions. The message delivery rules include instant message rules for delivering instant messages and presence update rules to control presence updating behavior. The instant message rules may include an “online messaging” rule for directing an instant messaging application to use online messaging, an “offline messaging rule” for directing an instant messaging application to store instant messages for subsequent online delivery, and an alternative messaging rule for an instant messaging application to use an alternative delivery method (e.g., SMS) to deliver instant messages. The message delivery rules may further include presence update rules for reporting presence information. The presence update rules may include a “standard update” rule for configuring the presence server to provide presence updates at a default reporting frequency, a “reduced update” rule to configure the presence server to provide presence updates at a reporting frequency lower than the default reporting frequency, and a “no update” rule to configure the presence server to suspend presence updates.

### BRIEF DESCRIPTION OF THE DRAWINGS

FIG. 1 is a block diagram of a communication network including an instant messaging and presence server according to one embodiment of the present invention.

FIG. 2 illustrates user registration states according to one embodiment of the invention.

FIG. 3 illustrates the functional components of an IMPS server according to one embodiment of the present invention.

FIG. 4 illustrates the functional components of an exemplary presence service element for the IMPS server according to one embodiment of the invention.

FIG. 5 illustrates machine states defined by an exemplary presence model according to one embodiment of the invention, and the relationship between machine states and user registrations states.

FIG. 6 illustrates one exemplary mapping of machine states to corresponding presence statuses according to one embodiment of the invention.

FIG. 7 illustrates another exemplary mapping of machine states to corresponding presence statuses according to one embodiment of the invention.

FIG. 8 illustrates an exemplary non-exclusive set of event and state transitions realized by the state machine.

### DETAILED DESCRIPTION

The present invention provides a method and apparatus for implementing instant messaging and presence service (IMPS) to enable the exchange of instant messages between mobile users, or between mobile users and fixed users. The IMPS solution according to the present invention defines and implements a presence model specifically adapted for mobile users.

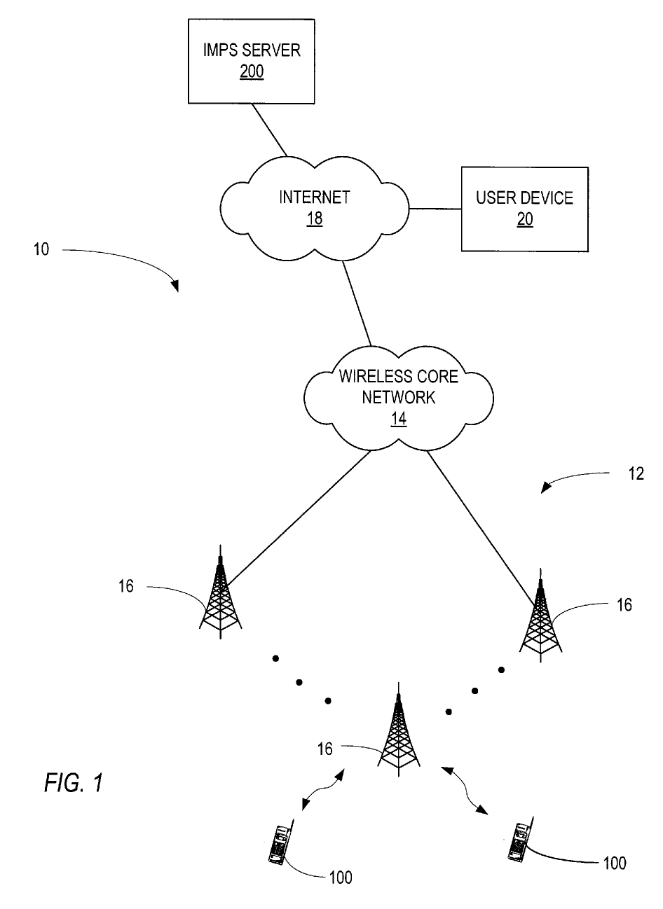

FIG. 1 illustrates an exemplary network 10 in which the present invention may be used. The network 10 comprises a plurality of mobile devices 100 having IMPS clients, a wireless access network 12 for communicating with the mobile devices 100, and a wireless core network 14 providing connection to the Internet 18 or other packet data network. The wireless access network 12 preferably comprises a packet-switched network, such as a GPRS, cdma2000, WCDMA, or WiMAX network. The wireless access network 12 includes one or more base stations 16 or other wireless access points. An IMPS server 200 connects to the Internet 18, or, alternatively, may reside in the wireless core network 14. The IMPS server 200 provides instant messaging and presence services to the mobile devices 100. The IMPS server 200 may also provide instant messaging and presence services to other user devices 20, such as desktop computers, with Internet connections.

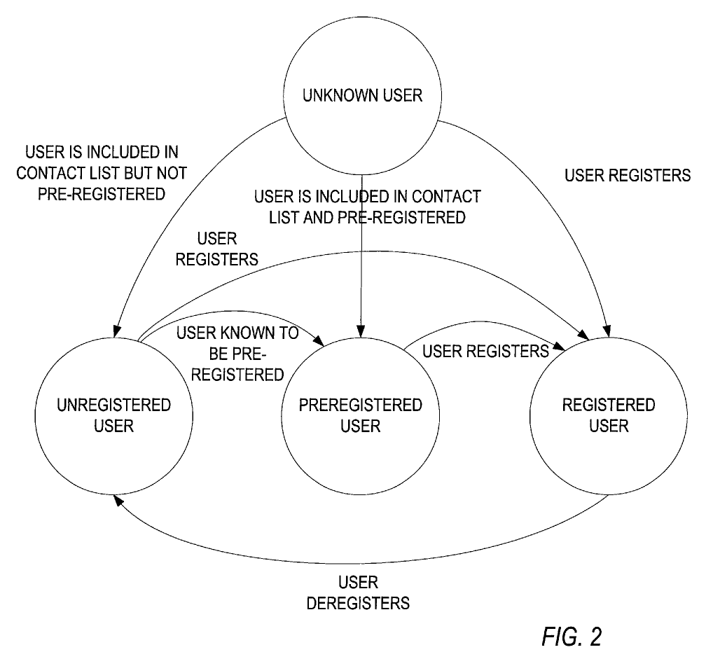

The mobile devices 100 have an IMPS client (not shown) for communicating with the IMPS server 200. The IMPS client is a software application that is executed on a processor and provides support for IMPS services to user applications, such as an instant messaging (IM) application or presence enhanced phone book. The users of the mobile devices 100 may register with the IMPS server 200 for instant messaging and presence services. A user can have one of three registrations states: registered, unregistered and pre-registered. The registrations states and events or conditions that cause transitions between registration states are shown in FIG. 2. A registered user is a user that has registered with the IMPS server 200 and has received an IMPS user ID. For purposes of this application, it is assumed that the registered users have a mobile device 100 with an IMPS client. A registered user can exchange instant messages and presence information with other registered users. A registered user may have a contact list for persons that the user converses with. A pre-registered user is one that has not registered, but has been pre-registered by the system operator and has been assigned an IMPS user ID. Registered users can interact on a limited basis with pre-registered users. For example, pre-registered users may have a contact list and may appear in contact lists for other users. When a registered user adds a pre-registered user to its contact list, the reciprocal add procedure can be used to add the registered user to the contact list for the pre-registered user. Thus, the pre-registered user may have access to a pre-populated contact list when the pre-registered user registers with the IMPS. An unregistered user is one that is included in the contact list of a registered user, but is not registered or pre-registered. An unregistered user does not have an IMPS user ID. A registered user cannot exchange presence updates with unregistered users. However, an instant message may be delivered to an unregistered user by alternative delivery methods, such as SMS.

Once registered, the mobile devices 100 can exchange instant messages, publish presence information, and subscribe to presence updates from other IMPS users. Presence information may, for example, reflect the current availability and/or willingness of the IMPS user to engage in an IM conversation. IMPS users may elect to make their presence status available to other IMPS users. IMPS users that provide presence information to other users are referred to as presentities. A user that wants to receive presence information from another user may subscribe to receive presence updates from the presentity of that user. An IMPS user that subscribes to receive presence updates from a presentity is referred to as a watcher. An IMPS user can be both a presentity and a watcher.

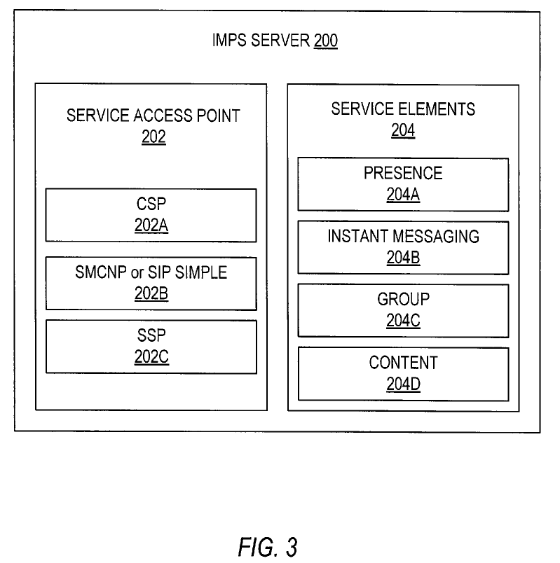

The IMPS server 200 maintains presence information for IMPS users and serves as an intermediary between presentities and watchers for publishing presence information. The IMPS server 200 implements a presence model described herein that is used to determine the presence states of presentities. FIG. 3 illustrates the functional entities of the IMPS server 200, which may be implemented as a software application running on a computer workstation or server. The IMPS server 200 comprises a service access point (SAP) 202 and one or more service elements 204. The SAP 202 authenticates users, performs service discovery and service negotiation, manages user profiles, and routes service requests and responses. The SAP 202 includes interfaces 202A, 202B, and 202C. Interface 202A implements a Client to Server Protocol (CSP) to provide access for IMPS clients residing on mobile devices 100, or on desktop computers. Interface 202B implements a Server to Mobile Core Network Protocol (SMCNP) to provide a connection to the mobile core network. The IMPS server 200 can receive system events from the mobile core network 14 over the SMCNP interface. As one example, the mobile core network 14 could notify the IMPS server 200 when a user connects or disconnects from the mobile network. Interface 202C implements a Server to Server Protocol (for example, the OMA SSP protocol or the OMA SIP/SIMPLE protocol) for connecting to other IMPS servers 200. The SSP or SIP/SIMPLE interface can be used, for example, to establish an interconnect route between IMPS servers to join distinct IMPS communities into a larger IMPS community. When an interconnect route is established between IMPS communities, IMPS users in one community can interact with IMPS users in the other community in the same manner as if they belonged to the same IMPS community, subject to any differences in implementation.

The service elements 204 include a presence service element 204A, an instant messaging service element 204B, a group service element 204C, and a content service element 204D. The presence service element 204A implements the presence model described herein and provides functionality for presence services. The instant messaging service element 204B provides functionality for sending and receiving instant messages between IMPS users. The group service element 204C provides functionality for defining and managing groups for IMPS users. The content service element 204D provides functionality for sharing content, such as images and documents between IMPS users. The IMPS server preferably complies with the Open Mobile Alliance (OMA) standard IMPS Architecture (OMS-AD-IMPS-V1_{—}3-20051011-C), which is incorporated herein by reference.

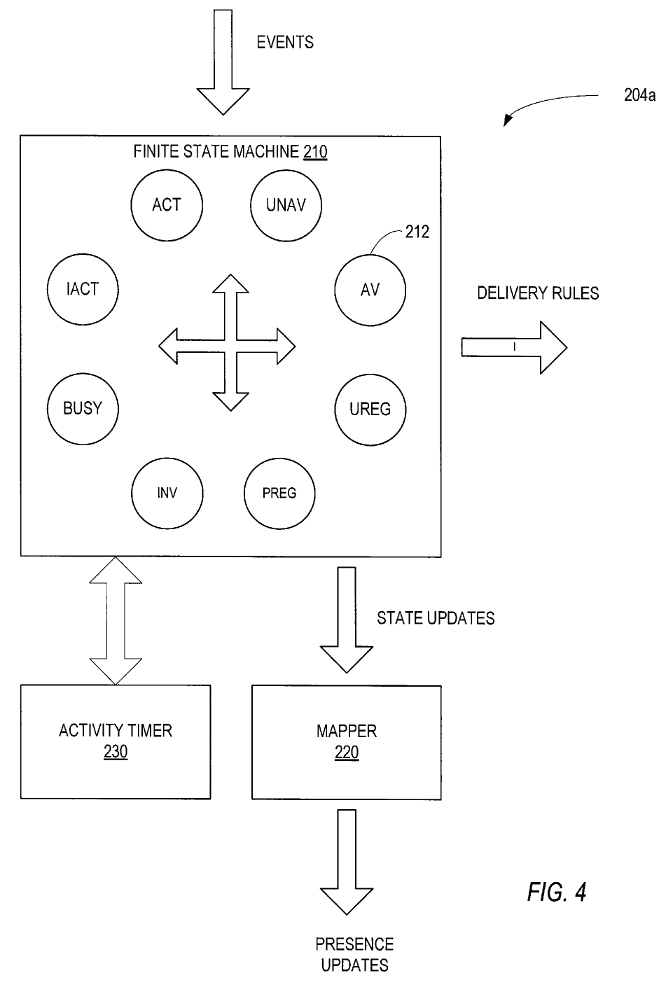

FIG. 4 illustrates the functional components of the presence service element 204A according to one exemplary embodiment of the present invention. Those skilled in the art will appreciate that the components illustrated in FIG. 4 may comprise software, hardware, firmware, or a combination thereof. The presence service elements 204A comprise a finite state machine 210, a mapper 220, and an activity timer 230. The finite state machine 210 maintains presence information based on the presence model described herein. In a preferred embodiment of the invention, each known user is represented by one dedicated instance of the finite state machine 210. The presence model implemented by the finite state machine 210 comprises a number of machine states 212, the transactions or events that result in transitions between the machine states 212, and the actions that take place when entering of leaving a machine state. The machine states are internal states and are not exposed to users. The mapper 220 performs a consolidation of the machine states 212 into corresponding presence statuses to provide an indication of the likelihood that a user will respond to an instant message. The operation of the mapper 220 is described in more detail below. The state machine 210 may use the activity timer 230 to monitor the activity level of the user.

The machine states 212 are defined by the presence model at a functional level without inferring them from presence statuses defined at the technology enabler level. At any given instant in time, the current state of the user is represented by one machine state 212. When a predetermined event occurs, or a predetermined condition is satisfied, the state machine 210 transitions between machine states 212. In response to a state transition, the state machine 210 outputs the current machine state 212 to the mapper 220. This output is referred to herein as a state update. The mapper 220, in turn, maps the current machine state 212 to a corresponding presence status.

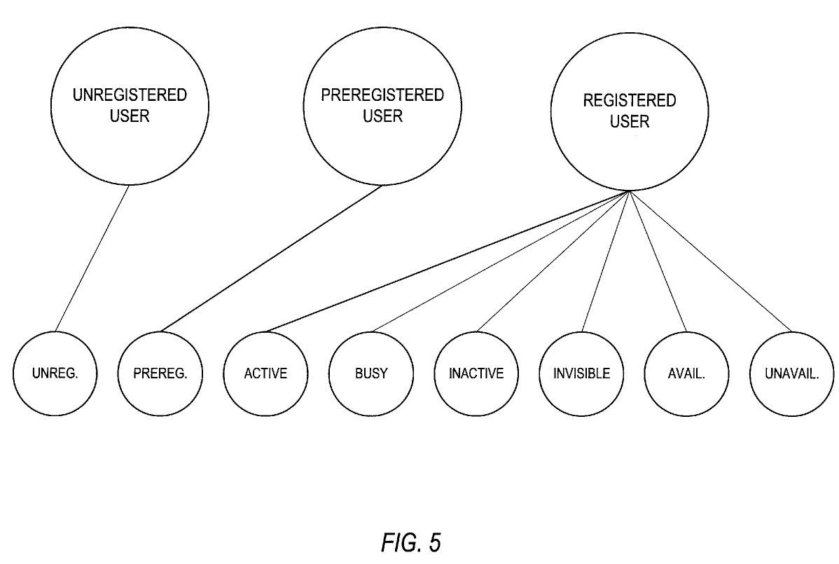

Table 1 below lists eight machine states 212 for one exemplary embodiment of the invention. The list of machine states 212 is illustrative only and those skilled in the art will recognize that additional machine states 212 may be defined. Each machine state corresponds to only one registration state. A registration, however, may have a plurality of corresponding machine states 212. Thus, the relationship between registration states and machine states 212 is one-to-many. The machine states 212 and corresponding registration states are shown in FIG. 5.

TABLE 1
Machine states

| | |
|---|---|
| Active | In this state, the user is currently actively engaged in |
| | instant messaging conversations. It is expected that the |
| | likelihood that the user will respond to an instant |
| | message is very high. |
| Available | In this state, the user is logged into the IMPS server 200, |
| | but is currently not involved in instant messaging |
| | conversations. However, the phone has been powered up |
| | and the likelihood that the user will respond to an instant |
| | message is high. The phone could be stored in a pocket |
| | or bag. However, if the user is notified (sound or |
| | vibration) then the user could pick up the phone and start |
| | conversing. |
| Inactive | In this state, although the IMPS client of the user is |
| | logged in, the user has not responded to recently |
| | received instant messages or the device of the user is |
| | switched off. The likelihood that the user will respond to a |
| | new message is very low. |
| Unavailable | In this state, the user has switched off his phone, phone |
| | is out of coverage, or the user has logged out of the IMPS |
| | server 200. The likelihood that the user will respond to a |
| | message is extremely low. If the user is in the inactive |
| | state for a long period of time (e.g. 1 or 2 months) then |
| | the system may automatically transition the user in the |
| | unavailable state. Note that the user may be logged into |
| | the IMPS server 200 while in this state. |
| Invisible | In this state, the user is logged into the IMPS server 200, |
| | but explicitly declares himself as unavailable. He wants to |
| | discourage instant messaging conversations. The |
| | likelihood that the user will respond to a message is low. |
| Busy | In this state, the user is logged into the IMPS server 200, |
| | but explicitly informs that he/she is not willing to get |
| | involved in instant messaging conversations. The |
| | likelihood that the user will respond to a message is very |
| | low. The user may be in a meeting and does not want to |
| | be disturbed with non-urgent matters. |
| Pre- | In this state, a user is not fully registered for the service |
| registered | and therefore cannot provide presence updates to other |
| | users, but has been assigned an IMPS user ID. However, |
| | depending on system capabilities, other users may still |
| | send instant messages to pre-registered users. These |
| | messages are converted for the purpose or being |
| | delivered to the pre-registered user via alternative |
| | messaging means, e.g. SMS. The pre-registered user |
| | has a non-accessible contact list which is provisioned |
| | with subscribers who have included this pre-registered |
| | user in their contact list (reciprocal add). |
| Unregistered | In this state, a user is not registered or pre-registered for |
| | the service but has been included in one or more contact |
| | lists. An unregistered user is not associated to any |
| | UserID (only known with mobile phone number) and an |
| | unregistered has no contact list. |

The finite state machine 210 for a given user transitions between machine states 212 when certain events occur, or when certain conditions are satisfied. Some events may be the result of intentional user action, such as launching an application, and logging into or out of the IMPS server. Other events may occur without user awareness. For example, the user may move into or out of coverage, or the mobile device may transparently log into or log out of the IMPS server 200 without user intervention. In a preferred embodiment of the invention, users may also have an option to declare their presence status. For example, the IM application on a mobile device 100 may have an option allowing users to make themselves “invisible’ so that they appear to be offline. As another example, a user may invoke a “do-not-disturb” function that makes the user appear “busy” to other users.

Table 2 below lists a number of events that can trigger a state transition in one exemplary embodiment. The list is intended to be illustrative and other events and other transitions may be defined.

TABLE 2
Events

| | Client | | Leaving | Entering |
|---|---|---|---|---|
| Event | Type | Condition | State | State |
| User logs in | Manual | Not launched as | Unavailable | Available or |
| | | response to an | | Active or |
| | | invitation from another | | Inactive |
| | | user. | | (depending |
| | | | | on operator |
| | | | | requirements) |
| | Manual | Launched as | Unavailable | Active |
| | | response to an | | |
| | | invitation from another | | |
| | | user. | | |
| | Background | Responsiveness was | Unavailable | Available |
| | | NOT low (e.g. during | | |
| | | past months) | | |
| | Background | Responsiveness was | Unavailable | Inactive |
| | | low (e.g. during past | | |
| | | months) | | |
| | X | | Invisible | Invisible |
| User logs OUT | X | | X | Unavailable |
| (or user is logged | | | | |
| out automatically | | | | |
| because session | | | | |
| with server has | | | | |
| terminated) | | | | |
| User declares | X | | X | Available |
| himself ‘available’ | | | | |
| User declares | X | | X | Busy |
| himself ‘busy’ | | | | |
| User declares | X | | X | Invisible |
| himself ‘invisible’ | | | | |
| User | X | Transition is triggered | Available | Active |
| sends/responds | X | by the user showing | Inactive | Active |
| to message | | activity such as | | |
| | | sending a message. | | |
| User's | X | Transition is triggered | Active | Available |
| responsiveness is | X | by the user showing | Available | Inactive |
| low | | some predetermined | | |
| | | level of inactivity (e.g., | | |
| | | the user has not been | | |
| | | responding to | | |
| | | messages for the last | | |
| | | 10 minutes.). | | |
| User has not | X | | Inactive | Unavailable |
| been using the | | | | |
| service (log-in, | | | | |
| changing | | | | |
| explicitly | | | | |
| presence status | | | | |
| or sending instant | | | | |
| message for a | | | | |
| long time (e.g., 1 | | | | |
| month) | | | | |
| Unregistered or | X | | Pre-reg. or | Unavailable |
| pre-registered | | | unregistered | |
| user registers to | | | or unknown | |
| the service | | | | |
| (without log IN) | | | | |
| Registered user | X | The user becomes an unknown user and the | | |
| has not been | | corresponding instance of the state machine 210 in | | |
| using the service | | the system is disabled. | | |
| for a certain | | | | |
| period of time | | | | |
| (e.g., 3 months). | | | | |
| User is being | X | Transition is triggered | Not known | Unregistered. |
| included in a | | by the user being | in the | |
| contact list, | | included in a contact | system. | |
| | | list in the following | | |
| | | contexts: | | |
| | | User is a local user | | |
| | | and service provider | | |
| | | does not allow pre- | | |
| | | registration of users. | | |
| | | User is a remote | | |
| | | user and there is no | | |
| | | interconnect with the | | |
| | | remote community | | |
| | | User is a remote | | |
| | | user. There is | | |
| | | interconnect with the | | |
| | | remote community. | | |
| | | The remote user is | | |
| | | not an IMP user and | | |
| | | the remote service | | |
| | | provider does not | | |
| | | support pre- | | |
| | | registration. | | |
| User is being | X | Transition is triggered | Not known | Pre- |
| included in a | | by the user being | in the | registered. |
| contact list | | included in a contact | system | |
| | | list in the following | | |
| | | contexts: | | |
| | | User is local user | | |
| | | and service provider | | |
| | | does support pre- | | |
| | | registration. | | |
| | | User is remote user | | |
| | | and remote service | | |
| | | provider does | | |
| | | support pre- | | |
| | | registration. | | |
| User from remote | X | This occurs for | Unregistered | Unavailable |
| community is | | instance when a new | or Pre-reg. | |
| known to be | | interconnect route is | | |
| registered. | | made available. It also | | |
| | | occurs when the user | | |
| | | registers. | | |
| User from remote | X | This occurs for | Unregistered | Pre- |
| community is | | instance when a new | | registered |
| known to be pre- | | interconnect route is | | |
| registered. | | made available. | | |
| User device | X | | X | Unavailable |
| attaches to | | | | (depending |
| roaming network | | | | on operator |
| | | | | requirements) |
| User device | X | | X | Unavailable |
| detaches from | | | | |
| network | | | | |
| User starts voice | X | | Available or | Busy |
| call | | | Active | |
| User ends voice | X | | Busy | Available |
| call | | | | |
| User launches | X | User has designated | Available or | Busy |
| application Z | | that during execution | Active | |
| | | of application Z, | | |
| | | he/she is not willing to | | |
| | | get involved in instant | | |
| | | messaging | | |
| | | conversations | | |
| User quits | X | User has designated | Busy | Available |
| application Z | | that during execution | | |
| | | of application Z, | | |
| | | he/she is not willing to | | |
| | | get involved in instant | | |
| | | messaging | | |
| | | conversations | | |

X denotes any client type or any “From” state

The event list shown in Table 2 assumes two types of IMPS clients, referred to herein as manual clients and background clients. With a manual client, the user must manually launch an instant messaging application in order to access to the IMPS server 200. For example, a JAVA client that is not automatically launched at power up is a manual client. In contrast, a background client is one that automatically launches and logs into the IMPS server 200 at device power up and automatically logs out and shuts down at power down. A background client is persistent and runs in the background even when the user is not engaged in an instant messaging conversation. For example, many mobile devices include a presence enhanced phone book. In this case, the IMPS client runs in the background to provide presence updates to the phone book even when the user is not engaged in an instant message conversation.

The output of the finite state machine 210 comprises state updates and message delivery rules. When the finite state machine 210 transitions between machine states 212, the finite state machine 210 outputs a state update to the mapper 220 reflecting the current machine state of the user. Because there is not a one-to-one correspondence between machine states 212 and presence statuses, the mapper 220 performs a consolidation in which multiple machine states 212 are mapped into a single presence status. The consolidation rules can be applied system wide, or, more preferably, may be dependent on specific user categories. The output of the mapper 220 is the current presence status of the user.

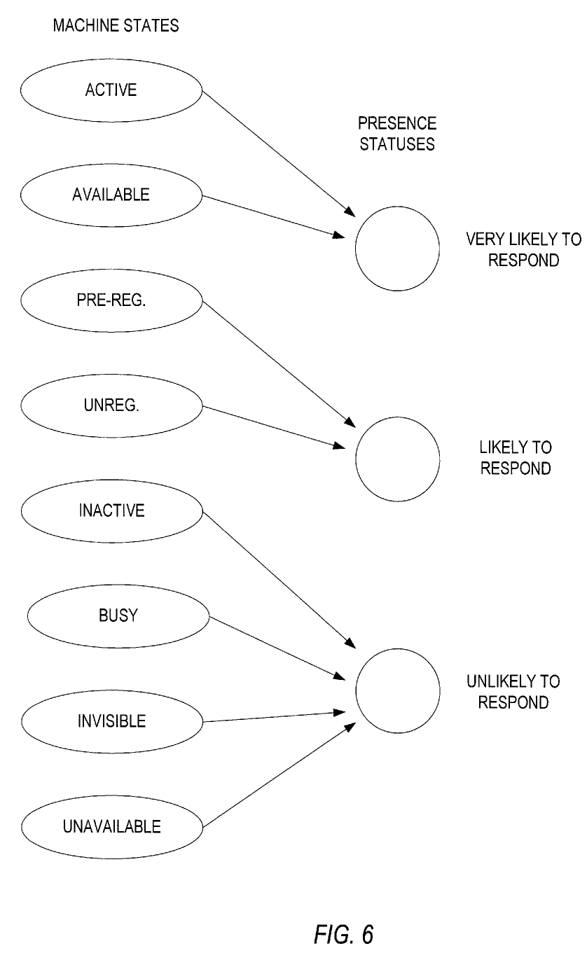

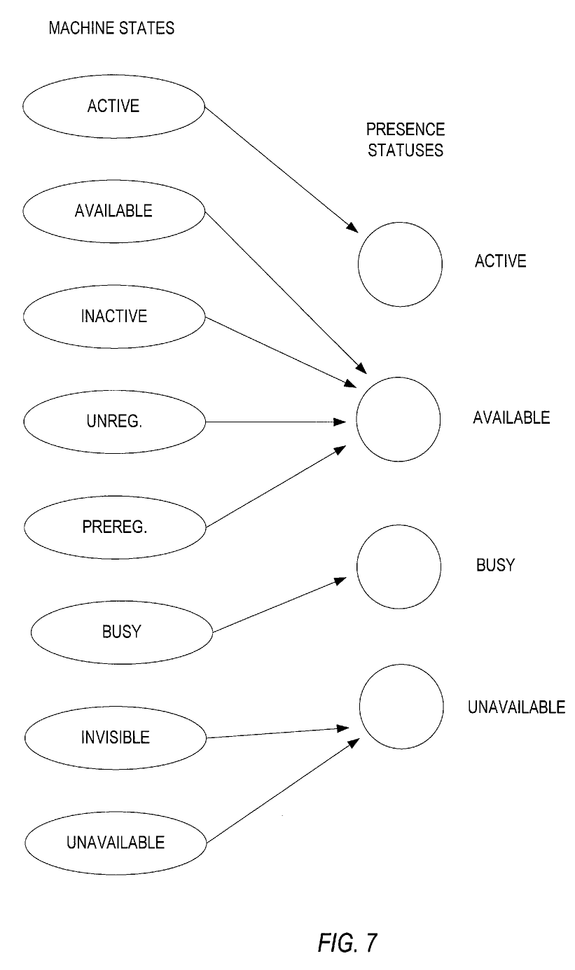

FIG. 6 illustrates an exemplary consolidation of machine states 212 into corresponding presence statuses. In the exemplary embodiment shown in FIG. 6, the presence status indicates the likelihood that a user will respond to an instant message. Such likelihood is affected both by the readiness of the user (e.g., is the user logged in) and the willingness of the user (e.g., user declares themselves invisible) to respond. FIG. 7 illustrates an alternate consolidation of machine states 212 into corresponding presence statuses.

The message delivery rules are a second form of output from the state machine 210. The message delivery rules specify how and whether instant messages and/or presence updates are delivered. When the finite state machine 210 transitions between states, a message delivery rule for instant messages, referred to herein as an instant message rule, may be output to the instant messaging service element 204B. Presence update rules are also defined to determine when the presence service element 204A delivers presence updates. Table 3 lists message delivery rules and their corresponding states.

TABLE 3
Delivery Rules

| Entering State | Instant Message Rule | Presence Update Rule |
|---|---|---|
| Active, Available, | Online messaging | Standard updates |
| Busy | | |
| Inactive | Online messaging | Reduced updates |
| Pre-registered, | Alternative messaging (i.e. | No presence updates |
| Unregistered | messages delivered via | |
| | alternative mechanism, e.g. | |
| | SMS) | |
| Unavailable | Offline messaging | No presence updates |
| Invisible | Offline messaging | Standard presence |
| | | updates |

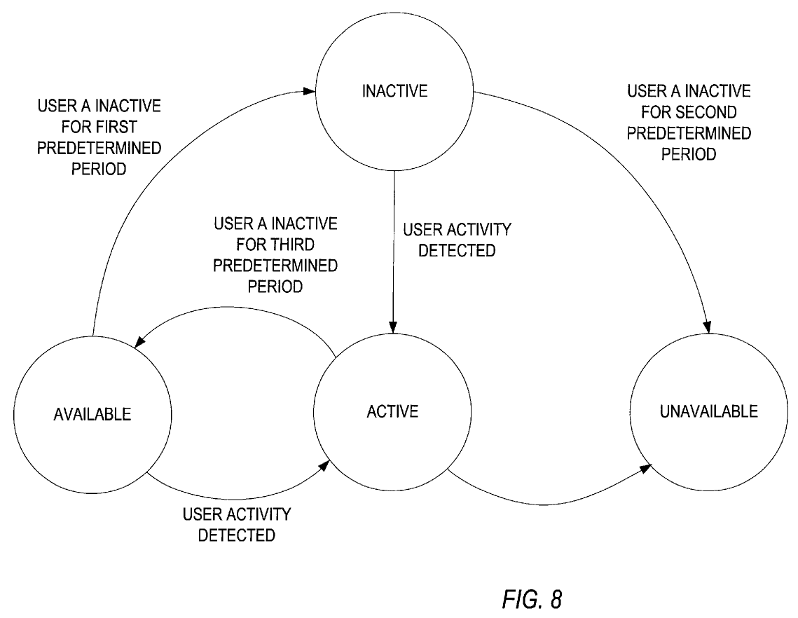

FIG. 8 illustrates exemplary events and state transitions realized by the sate machine 210 to illustrate the operation of the state machine. This example and the event and transitions are not meant to be exclusive. An IMPS user, denoted as User A, is currently in the “Available” state. In this state, User A is logged in to the IMPS server 200, but is not currently involved in an instant messaging conversation. The state machine 210 may use the activity timer 230 to monitor the activity level of User A and transition between states based on the activity level. If User A remains inactive for a predetermined period of time (e.g. 30 min.) while in the “Available” state, the state machine 210 will transition to the “Inactive” state. If User A remains inactive for a second predetermined period of time (e.g., 24 hrs) after transitioning to the “Inactive” state, the state machine 210 for that user will transition to the “Unavailable” state. If User A sends an instant message, or responds to an instant message, the state machine 210 will transition to the “Active” state. Once in the “Active” state, the state machine will monitor user activity and transition back to the “Available” state if the user is inactive for a third predetermined period of time (e.g., 10 min).

Some standardization bodies have already defined a set of presence statuses to be supported by IM clients or to be conveyed over interconnect interfaces. For example, the GSM Association (GSMA) standard IM SPT Phase 1 recommends the following presence statuses: on-line, on-line but unavailable, and off-line. The OMA standard for IMPS (OMA-IMPS-WV-PA-V1_{—}2-20050125-A) defines two relevant presence attributes: OnlineStatus and UserAvailability. The OnlineStatus attribute is a Boolean value that indicates whether the user is currently online. The OnlineStatus attribute takes the following values:
True—the client is logged into the IMPS service
False—the client is not logged into the IMPS service
   The UserAvailability attribute indicates the availability of the user for instant messaging and takes the following values:
Available—the user is available for communication
Not Available—the user is not available for communication.
Discreet—Communication with the publisher is left to the discretion of the user.

The mapper 220 can accommodate different presence statuses defined by different standardization bodies. Such flexibility may be necessary because some IMPS clients may be limited to a defined set of presence statuses. For example, the IM client for a user or mobile operator providing service may support only the GSMA presence statuses. Table 4 illustrates one possible mapping of machine states into presence statuses/attributes for GSMA and OMA IMPS.

TABLE 4
Mapping Rules for GSMA and OMA IMPS

| | GSMA | | |
|---|---|---|---|
| | recommended | | |
| | presence | OMA IMPS | |
| Machine states | information | OnlineStatus | UserAvailability |
| Active | Online | True | Available |
| Available | Online | True | Available |
| Inactive | Online | True | Not Available |
| Unavailable | Offline | False | Not Available |
| Invisible | Offline | False | Not Available |
| | | (as published, but | |
| | | the user can still be | |
| | | logged in) | |
| Busy | Online but | True | Discreet |
| | unavailable | | |
| Pre-registered | Online/Offline | True/False | Available/Not |
| | (depending on | (depending on | available |
| | operator | operator | (depending on |
| | requirements) | requirements) | operator |
| | | | requirements) |
| Unregistered | Online/Offline | True/False | Available/Not |
| | (depending on | (depending on | available |
| | operator | operator | (depending on |
| | requirements) | requirements) | operator |
| | | | requirements) |

It has been assumed that the events and transitions are predefined and static. Increasing the number of conditions and/or system events can increase significantly the complexity of the state machine 210. Rather than defining statically the events and conditions when transitions shall occur between machine states 212, the state machine 210 could include logic to learn user behaviors and to adapt transitions between states accordingly. For example, the state machine 210 could implement a neural network to learn user behaviors. To illustrate the learning process, consider the scenario in which User A goes to a recurrent meeting every Monday morning. The state machine 210 logic initially provides that if the user is having a meeting (according to user's agenda in the phone), the user should be shown as unlikely to respond. However, during Monday morning meetings, User A typically responds to instant messages. The state machine 210 dynamically learns this behavior and, as a consequence, changes its internal logic so that during Monday morning meetings, the status of User A is shown as ‘likely to respond’. Now assume that User A has another recurrent meeting on Tuesday mornings. However, during this meeting, User A never responds to instant messages. The system also dynamically learns this behavior and adapts the presence status shown to others.

The present invention may, of course, be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A presence server comprising:
a state machine to maintain current machine states for a plurality of users and to generate state updates indicative of the current machine states of said users responsive to state transitions; and
a mapper to receive said state updates from said state machine and to map said current machine states of said users to corresponding presence statuses.

2. The presence server of claim 1 wherein each user is represented by one instance of said state machine.

3. The presence server of claim 1 wherein the machine states of the state machine include the “Available” state, the “Inactive” state, and the “Unavailable” state.

4. The presence server of claim 3 wherein the state machine is configured to enter the “Available” state when the corresponding user logs into the presence server.

5. The presence server of claim 4 wherein the state machine is configured to transition from the “Available” state to the “Inactive” state when the user is inactive for a first predetermined period of time.

6. The presence server of claim 5 wherein the state machine is configured to transition from the “Inactive” state to the “Unavailable” state when the user is inactive for a second predetermined period of time.

7. The presence server of claim 6 wherein the machine states of the state machine further include a “Active” state.

8. The presence server of claim 7 wherein the state machine is configured to enter the “Active” state when the corresponding user logs into the presence server in response to an invitation from another user.

9. The presence server of claim 7 wherein the state machine is configured to transition from the “Inactive” state or the “Available” state to the “Active” state responsive to the detection of user instant messaging activity.

10. The presence server of claim 9 wherein the state machine is configured to transition from the “Active” state to the “Available” state when the user is inactive for a third predetermined period of time.

11. The presence server of claim 1 wherein the state machine further generates message delivery rules responsive to state transitions.

12. The presence server of claim 11 wherein said message delivery rules include instant message rules for delivering instant messages.

13. The presence server of claim 12 wherein said instant message rules include an “online messaging” rule, an “offline messaging rule” and an alternative messaging rule.

14. The presence server of claim 13 wherein the “online messaging” rule directs an instant messaging application to use online messaging.

15. The presence server of claim 13 wherein the “offline messaging” rule directs an instant messaging application to store instant messages for subsequent online delivery.

16. The presence server of claim 13 wherein the “alternative messaging” rule directs an instant messaging application to use an alternative delivery method to deliver instant messages.

17. The presence server of claim 11 wherein said message delivery rules include presence update rules for reporting presence information.

18. The presence server of claim 17 wherein said presence update rules include a “standard update” rule, a “reduced update” rule, and a “no update” rule.

19. The presence server of claim 18 wherein the “standard update” rule configures the presence server to provide presence updates at a default reporting frequency.

20. The presence server of claim 18 wherein the “reduced update” rule configures the presence server to provide presence updates at a reporting frequency lower than the default reporting frequency.

21. The presence server of claim 18 wherein the “no update” rule configures the presence server to suspend presence updates.

22. A method of providing presence updates, said method comprising:
maintaining current machine states for a plurality of users and generating state updates indicative of the current machine states of said users responsive to state transitions; and
mapping current machine states of said users to corresponding presence statuses.

23. The method of claim 22 wherein said current machine states of said users are maintained by a state machine.

24. The method of claim 23 wherein said current machine states of said users are maintained by a dedicated state machine for each user.

25. The method of claim 22 wherein the machine states of the state machine include the “Available” state, the “Inactive” state, and the “Unavailable” state.

26. The method of claim 25 wherein the state machine is configured to enter the “Available” state when the corresponding user logs into the presence server.

27. The method of claim 26 wherein the state machine is configured to transition from the “Available” state to the “Inactive” state when the user is inactive for a first predetermined period of time.

28. The method of claim 27 wherein the state machine is configured to transition from the “Inactive” state to the “Unavailable” state when the user is inactive for a second predetermined period of time.

29. The method of claim 28 wherein the machine states of the state machine further include a “Active” state.

30. The method of claim 29 wherein the state machine is configured to enter the “Active” state when the corresponding user logs into the presence server in response to an invitation from another user.

31. The presence server of claim 29 wherein the state machine is configured to transition from the “Inactive” state or the “Available” state to the “Active” state responsive to the detection of user instant messaging activity.

32. The presence server of claim 31 wherein the state machine is configured to transition from the “Active” state to the “Available” state when the user is inactive for a third predetermined period of time.

33. The method of claim 22 further comprising generating message delivery rules responsive to said state transitions.

34. The method of claim 33 wherein said message delivery rules include instant messaging rules for delivering instant messages.

35. The method of claim 34 wherein said instant message rules include an “online messaging” rule, an “offline messaging rule” and an alternative messaging rule.

36. The method of claim 35 wherein the “online messaging” rule directs an instant messaging application to use online messaging.

37. The method of claim 35 wherein the “offline messaging” rule directs an instant messaging application to store instant messages for subsequent online delivery.

38. The method of claim 35 wherein the “alternative messaging” rule directs an instant messaging application to use an alternative delivery method to deliver instant messages.

39. The method of claim 33 wherein said message delivery rules include presence update rules for providing presence updates.

40. The method of claim 39 wherein said presence update rules include a “standard update” rule, a “reduced update” rule, and a “no update” rule.

41. The method of claim 40 wherein the “standard update” rule configures the presence server to provide presence updates at a default reporting frequency.

42. The method of claim 40 wherein the “reduced update” rule configures the presence server to provide presence updates at a reporting frequency lower than the default reporting frequency.

43. The method of claim 40 wherein the “no update” rule configures the presence server to suspend presence updates.
